(19) United States
(12) Patent Application Publication
(10) Pub. No.: US 2010/0174400 A1
(43) Pub. Date: Jul. 8, 2010

(54) Garment manufacturing method

(76) Inventor: Henry Lai, HsinTien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,775

(22) Filed: Jan. 8, 2009

(51) Int. Cl. G06F 19/00

(52) U.S. Cl. 700/132; 700/134; 700/136

(57) ABSTRACT

A garment manufacturing method edits an original drawing having the style of an artistic aesthetic color pattern that goes through the processes of removing background and changing colors, and adopting a designer's fashion design sketch to impose a new pattern from the original drawing to a new fashion design drawing. The style of the fashion is designed by computer pieces, wherein front pieces and back pieces of a garment are arranged to retrieve a new pattern of the original drawing, and computer template pieces are patterned to print a newly created digital graphic file on a blank fabric, and the fabric is cut and sewed according to the template to achieve the effect of fixing the template pieces at desired positions to show the overall expression of lines and patterns of the garment and manifest the visual aesthetic design of the invention.

### BACKGROUND OF THE INVENTION

1. Field of the Invention

The present invention relates to a garment manufacturing method, and more particularly to a novel garment manufacturing method that edits an original drawing having the style of an artistic aesthetic color pattern that goes through the processes of removing background and changing colors, and adopting a designer's fashion design sketch to impose a new pattern from the original drawing to a new fashion design drawing. The style of the fashion is designed by computer pieces, wherein front pieces and back pieces of a garment are arranged to retrieve a new pattern of the original drawing, and computer template pieces are patterned to print a newly created digital graphic file on a blank fabric, and the fabric is cut and sewed according to the template to achieve the effect of fixing the template pieces at desired positions to show an overall expression of lines and patterns and manifest the visual aesthetic design of the garment.

2. Description of the Related Art

At present, printing methods adopted by the textile technology of printing fabrics include a screen printing and an offset roller printing, etc. In the traditional screen printing technology, an ink dye is permeated through many fine meshes and attached on a surface of a desired printing object, and the major tool of the screen printing is the screen which is generally made by a molding process according to a required pattern and framed with a metal or wooden frame, and a layer of elastic thin film is coated onto the screen, and a portion of the pattern on the thin film is composed of a plurality of fine meshes. In the printing process, the ink dye in a paste form is squeezed onto edges of the pattern, and then a rubber spatula is used for scraping the pattern gently with a slight pressure to complete the printing. However, the screen printing requires a spatula for the printing of a pattern, and another spatula for printing another pattern, and thus traditional screen printing incurs more labor and higher manufacturing cost.

In the traditional offset roller printing technology, a whole roll of blank fabric is wound at a feeding machine and conveyed to an offset roller printing machine, and the plurality of rollers transfer printing the ink dye to a printing pattern of a master template. In general, the traditional master template is usually an image template of the printing technology and wound and fixed around the external periphery a transmission roller, and the print pattern on the master template comes with a feature of high ink adhesiveness that allows printers to print the ink dye onto the blank fabric completely and accurately.

In the aforementioned traditional printing methods, regardless of the screen of the screen printing or the master template of the offset roller printing, their size is restricted, and thus the size of the printed lines and patterns is limited, and the screen or master template is used for printing lines and patterns repeatedly for printing a large piece of fabric.

With reference to FIGS. 1 to 10 for a general traditional garment manufacturing method, after an original drawing 11 goes through background removal and color change 12 to print major lines and patterns 10 and performs a pattern printing 13 by a screen printing method or an offset roller printing method, and the performs a stylish design adoption 15 to the printed fabric according to the designer's fashion design sketch 14, and a pattern, and arranges the portions including a front piece and a back piece of the garment by a template piece design 16, and performs a template piece adoption 17 to the fabric, and a template piece cutting 18 to sew and complete manufacturing the traditional garment product 19.

In the foregoing traditional garment manufacturing method, the fabric printed with lines and patterns are cut into a garment template according to the size of the garment, and the template will affect the positions of the lines and patterns shown in the garment. As we all know, the size is mainly divided into small (S), medium (M), large (L) and extra large (XL), and different templates will give different sizes of a garment. With the same lines and patterns printed on a fabric, the positions of the lines and patterns for the garments made by the template for small (S) size and the template for medium (M) size will be different, and thus it is necessary to make corresponding screens or master templates according to the template for the desired size specifically, and thus the manufacturing cost will be higher and the fabric with lines and patterns printed at the appropriate positions will be wasted.

In the traditional garment manufacturing method, template pieces including front pieces and back pieces are designed and arranged in desired positions, and the fabric goes through a piece patterning to save fabric materials. The utility of the template pieces including the front pieces and the back pieces is maximized, and thus the consumption of fabric is minimized, so that a maximum number of template pieces can be laid on the fabric to avoid irregular distributed patterns over the fabric, or main lines and patterns 10 that are not shown completely and the artistic aesthetic design that is ruined.

### SUMMARY OF THE INVENTION

In view of the foregoing shortcomings of the prior art, the inventor of the present invention based on years of experience in the related industry to conduct extensive researches and experiments, and finally invented a garment manufacturing method in accordance with the present invention to overcome the shortcomings of the prior art.

Therefore, it is the primary objective of the present invention to provide a garment manufacturing method that edits an original drawing having the style of an artistic aesthetic color pattern and going through the processes of removing background and changing colors, and adopting a designer's fashion design sketch to impose a new pattern from the original drawing to a new fashion design drawing. The style of the fashion is designed by computer pieces, wherein front pieces and back pieces of a garment are arranged to retrieve a new pattern of the original drawing, and computer template pieces are patterned to print a newly created digital graphic file on a blank fabric, and the fabric is cut and sewed according to the template to achieve the effect of fixing the template pieces at desired positions to show the overall expression of lines and patterns of the garment and manifest the visual aesthetic design of the present invention.

### BRIEF DESCRIPTION OF THE DRAWINGS

FIG. 1 is a flow chart of a traditional garment manufacturing method;

FIG. 2 is a schematic view of an original drawing 11 of the prior art;

FIG. 3 is a schematic view of background removal and color change 12 in accordance with the prior art;

FIG. 4 is a schematic view of fabric printing 13 in accordance with the prior art;

FIG. 5 is a schematic view of a fashion design sketch 14 in accordance with the prior art;

FIG. 6 is a schematic view of a stylish design adoption 15 in accordance with the prior art;

FIG. 7 is a schematic view of a template piece design 16 in accordance with the prior art;

FIG. 8 is a schematic view of a template piece adoption 17 in accordance with the prior art;

FIG. 9 is a schematic view of a template piece cutting 18 in accordance with the prior art;

FIG. 10 is a schematic view of a garment product 19 in accordance with the prior art;

FIG. 11 is a flow chart of a garment manufacturing method in accordance with the present invention;

FIG. 12 is a schematic view of an original drawing 21 in accordance with the present invention;

FIG. 13 is a schematic view of background removal and color change 22 in accordance with the present invention;

FIG. 14 is a schematic view of a fashion design sketch 23 in accordance with the present invention;

FIG. 15 is a schematic view of a stylish design sketch 24 in accordance with the present invention;

FIG. 16 is a schematic view of a computer template piece design 25 in accordance with the present invention;

FIG. 17 is a schematic view of a computer template piece adoption 26 in accordance with the present invention;

FIG. 18 is a schematic view of a digital pattern printing 27 in accordance with the present invention; and

FIG. 19 is a schematic view of a garment product 28 in accordance with the present invention.

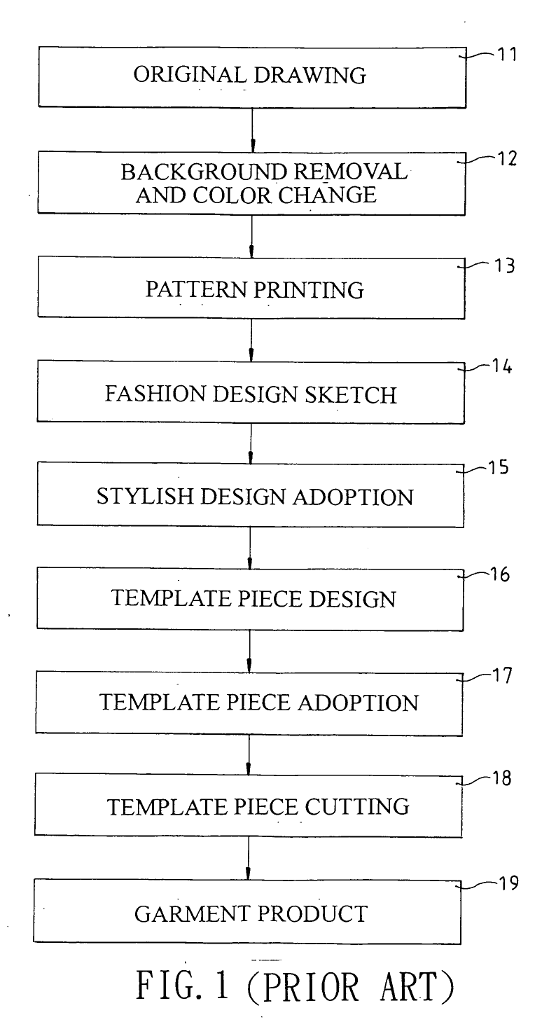

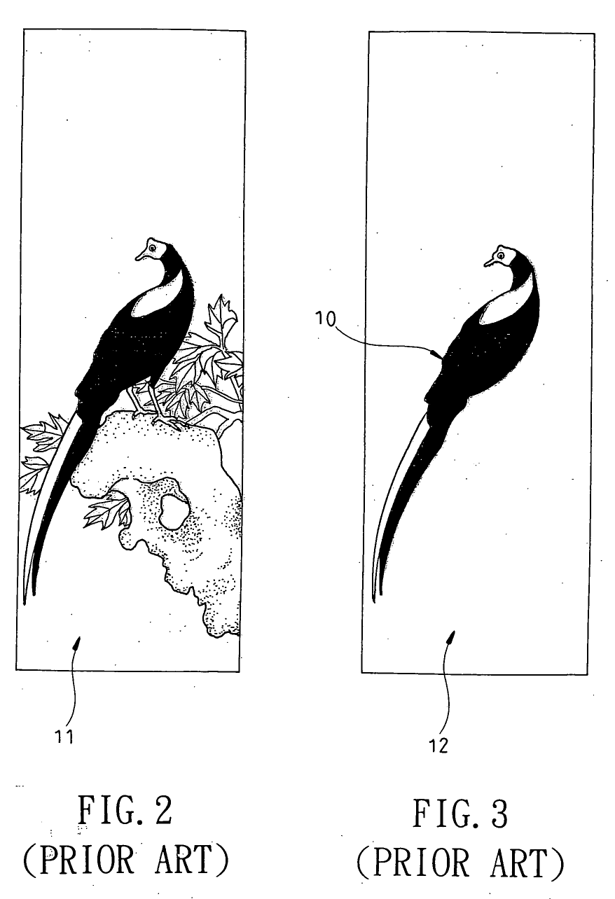

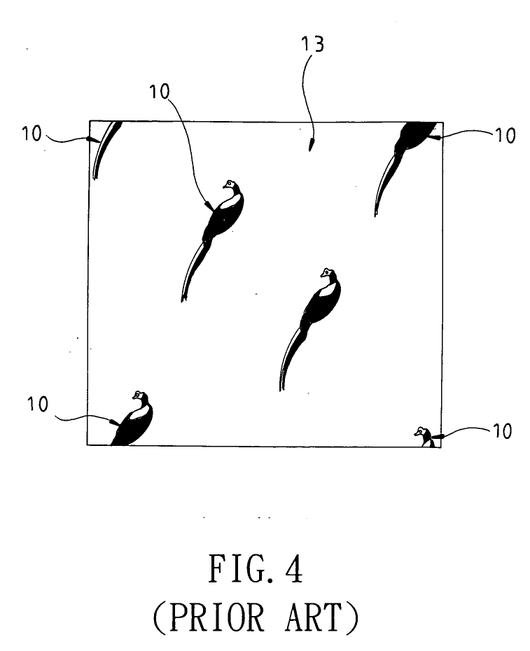

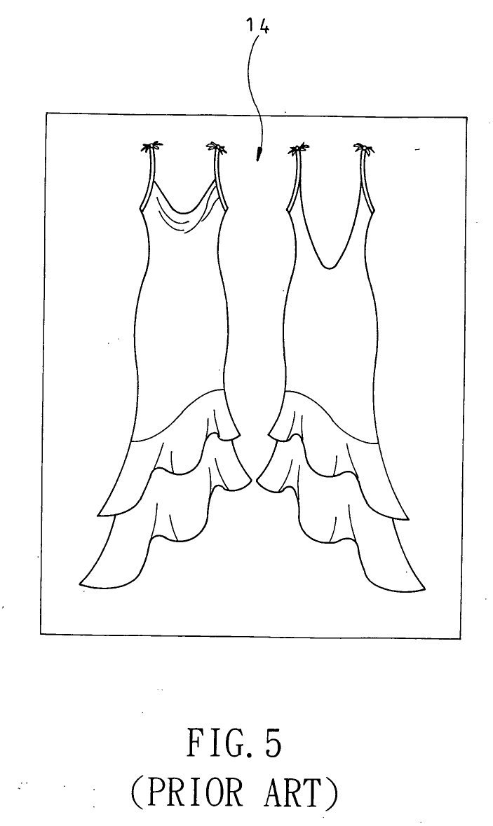

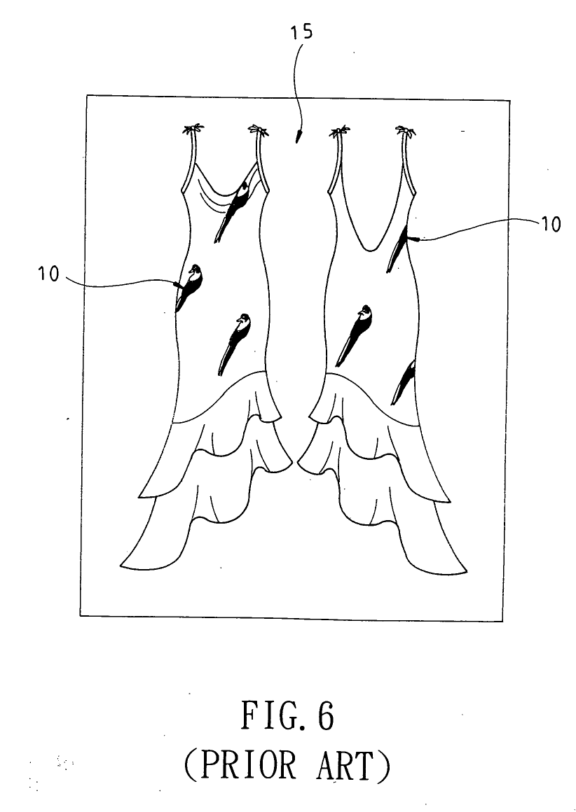

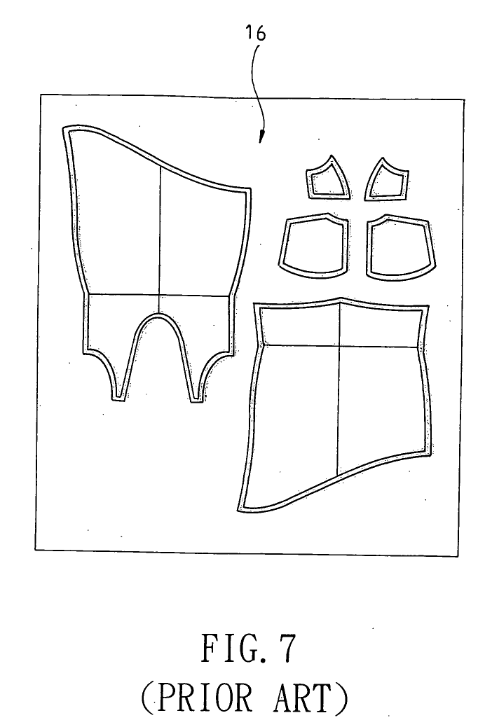

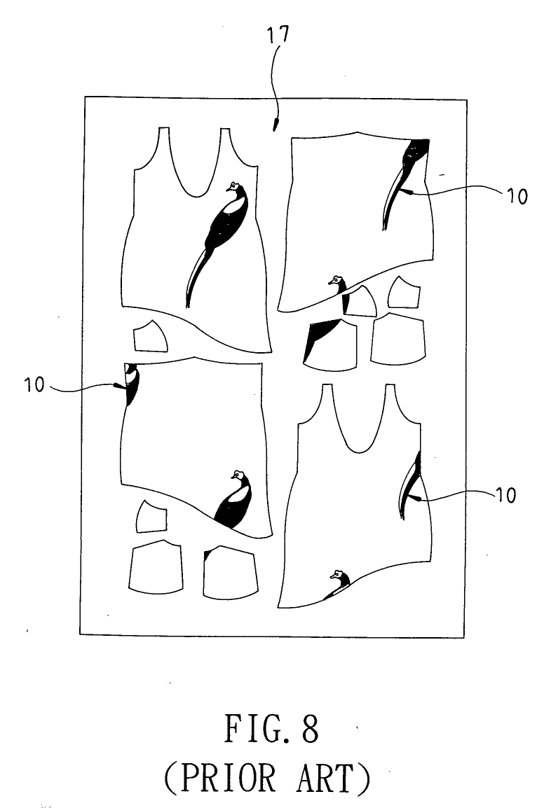

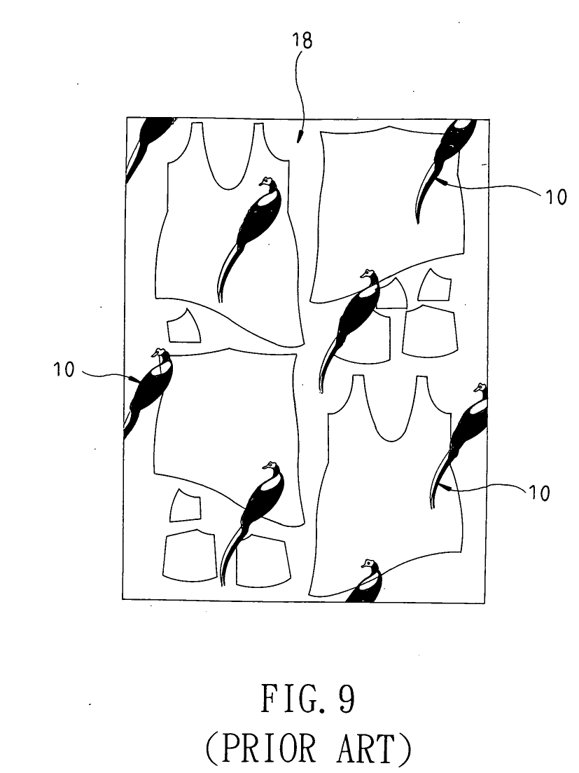

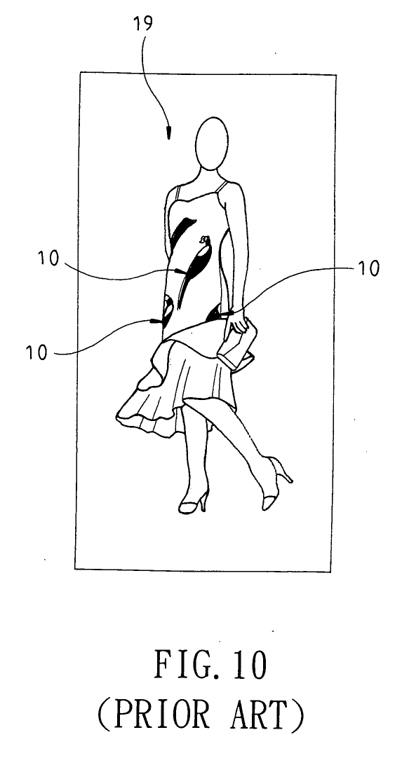

### DETAILED DESCRIPTION OF THE PREFERRED EMBODIMENTS

To make it easier for our examiner to understand the technical characteristics of the garment manufacturing method of the invention, preferred embodiments and related drawings are used for the detailed description of the present invention as follows.

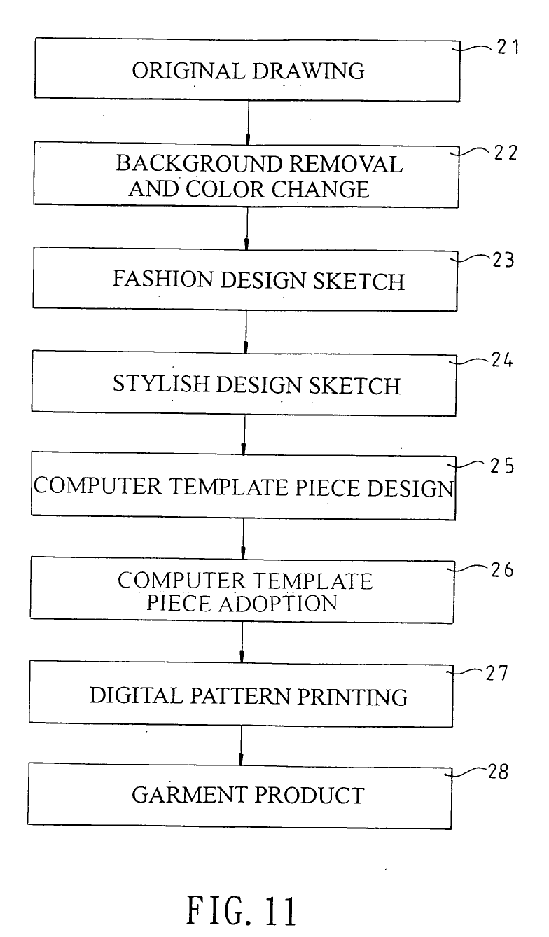

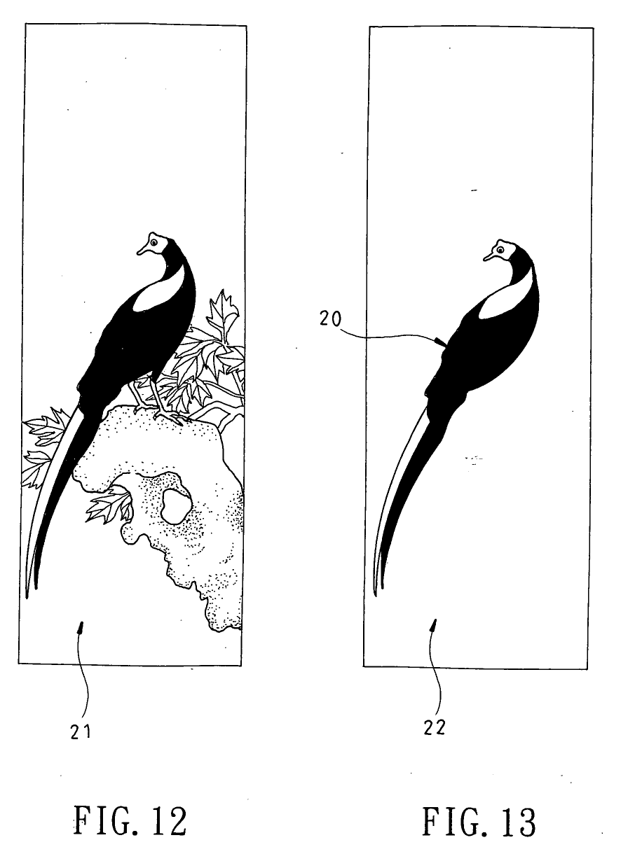

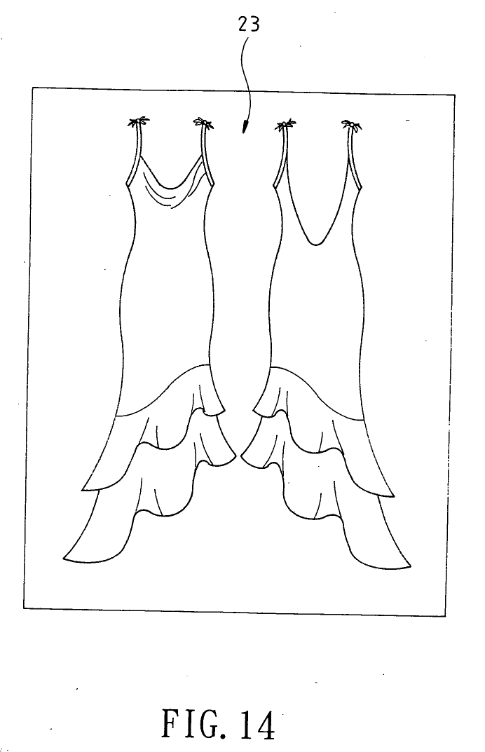

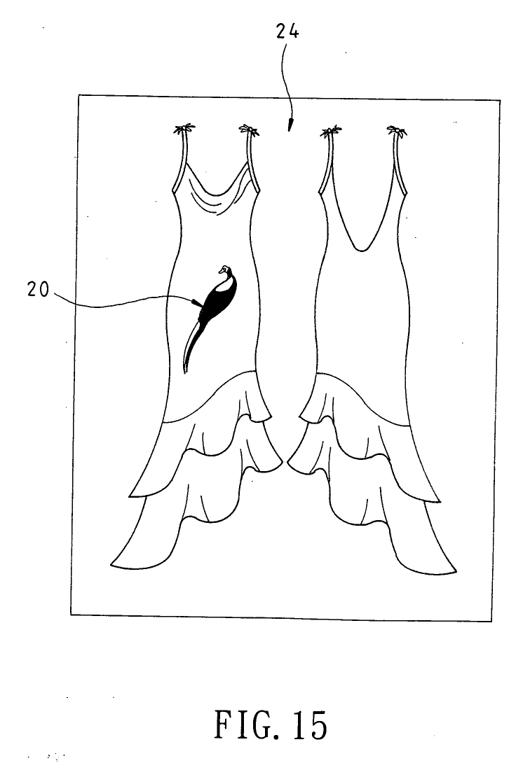

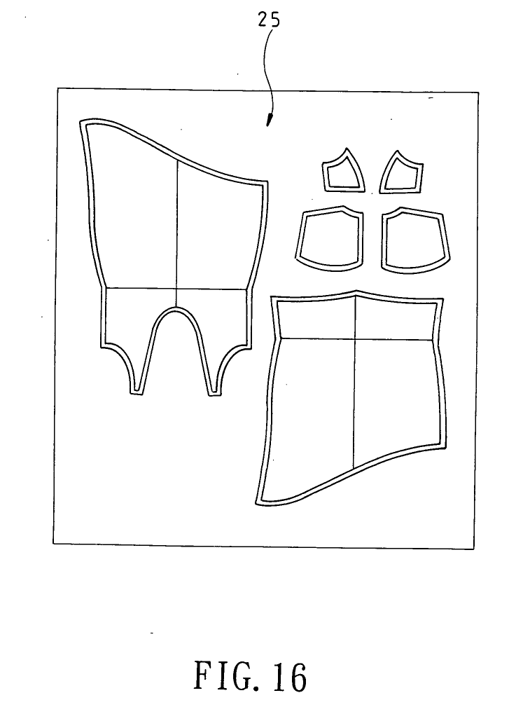

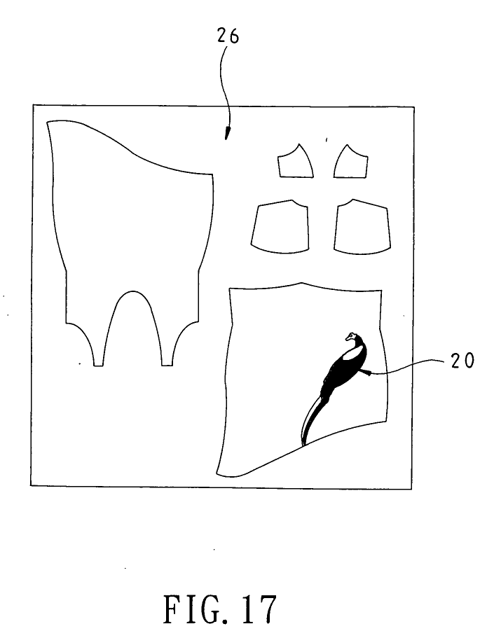

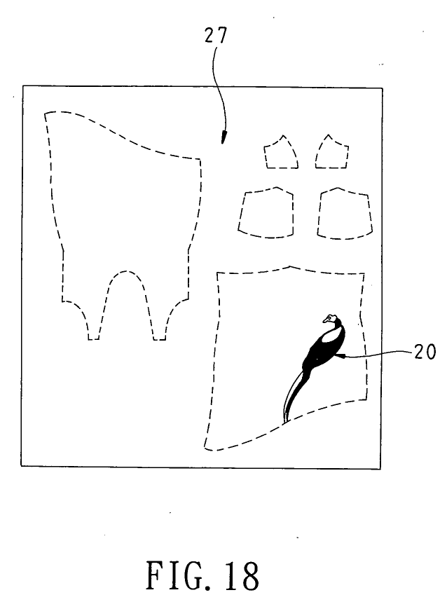

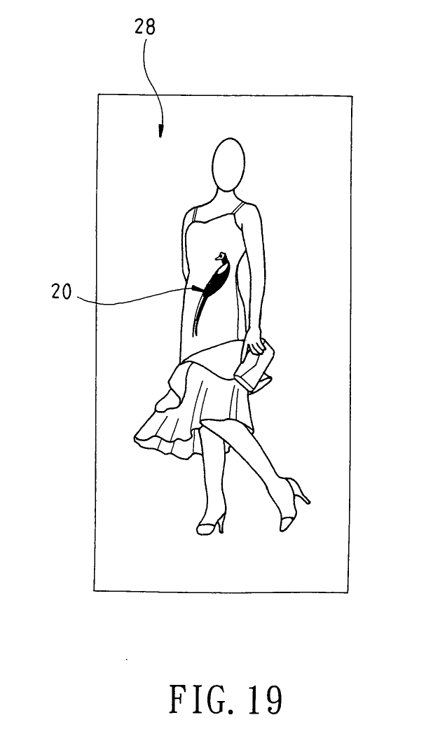

With reference to FIGS. 11 to 19 for a garment manufacturing method in accordance with the present invention, the method comprises the following steps:

(A) producing an original drawing 21, and entering the original drawing 21 into a computer for an image digitization process, wherein the original drawing 21 is a designer's simple hand-drawn draft or a famous painter's antique painting;

(B) performing background removal and color change 22 to the digitized original drawing 21;

(C) performing a stylish design sketch 24 according to a fashion designer's fashion design sketch 23, lines and pattern;

(D) arranging positions of front pieces and back piece of a garment by a computer template piece design 25, while performing a computer template piece adoption 26;

(E) entering a graphic file of the computer template piece adoption 26, and outputting the graphic file to a printing machine for performing a digital pattern printing 27 of the graphic file onto a blank fabric; and

(F) cutting and sewing pieces according to a template piece cutting to complete a garment product 28.

In the aforementioned garment manufacturing method of the invention, a garment can be manufactured from the original drawing with a style of artistic aesthetic color pattern, and its effect is maximized skillfully to show the elegant fashion of the oriental art.

The main characteristic of the present invention resides on the garment manufacturing method that edits an original drawing having the style of an artistic aesthetic color pattern that goes through the processes of removing background and changing colors, and adopting a designer's fashion design sketch to impose a new pattern from the original drawing to a new fashion design drawing. The style of the fashion is designed by computer pieces, wherein front pieces and back pieces of a garment are arranged to retrieve a new pattern of the original drawing, and computer template pieces are patterned to print a newly created digital graphic file on a blank fabric, and the fabric is cut and sewed according to the template to complete a novel garment product. The garment achieves the effect of fixing the lines and patterns 20 of the garment at desired positions to show the visual aesthetic design and the artistic value.

Another advantage of the invention resides on that the digital pattern printing is -not limited by the size of the template pieces, regardless of the small (S), medium (M), large (L) and extra large (XL) to produce patterns and fashion designs according to an original drawing, and enlarge or reduce the main lines and patterns 20 in proportion and arrange the main lines and patterns 20 at appropriate positions, such that when the front pieces and the back pieces of the garment are sewed together, a garment with artistic lines and patterns and in compliance with the creative fashion design can be manufactured easily.

In summation of the description above, the present invention improves over the prior art, and complies with the requirements of patent application, and thus is duly filed for patent application.

While the invention has been described by means of specific embodiments, numerous modifications and variations could be made thereto by those skilled in the art without departing from the scope and spirit of the invention set forth in the claims.

1. A garment manufacturing method, comprising the steps of:
(A) pre-establishing an original drawing, and entering the pre-established original drawing into a computer for an image digitization process;
(B) performing a background removal and color change process to the digitized original drawing to generate a digital pattern;
(C) pre-establishing a stylish design sketch according to a fashion designer's fashion design sketch, lines and pattern;
(D) arranging positions of front pieces and back piece of a garment by a computer template piece design, and performing a computer template piece adoption to incorporate a layout of the digital pattern positioned relative to the front and back pieces according to the pre-established stylish design sketch;
(E) entering a graphic file of the computer template piece adoption, and outputting the graphic file to a printing machine for printing the digital pattern extracted from the layout onto a blank fabric; and
(F) cutting and sewing pieces according to a template piece cutting to complete a garment product.
